(19) United States
(12) Patent Application Publication
(10) Pub. No.: US 2016/0274335 A1
(43) Pub. Date: Sep. 22, 2016

(54) IMAGING LENS AND IMAGING APPARATUS

(71) Applicant: FUJIFILM Corporation, Tokyo (JP)

(72) Inventor: Daiki KAWAMURA, Saitama-shi (JP)

(73) Assignee: FUJIFILM Corporation, Tokyo (JP)

(21) Appl. No.: 15/064,123

(22) Filed: Mar. 8, 2016

(30) Foreign Application Priority Data
Mar. 16, 2015 (JP) 2015-052258

(51) Int. Cl. G02B 13/02; G02B 13/00; G02B 27/00; G02B 9/64

(52) U.S. Cl. CPC G02B 13/02; G02B 9/64; G02B 13/006; G02B 27/0025

(57) ABSTRACT

An imaging lens is constituted by, in order from the object side to the image side, a first lens group having a positive refractive power; a second lens group having a negative refractive power; and a third lens group having a positive refractive power. An aperture stop is positioned at the object side of the second lens group. The first lens group has at least two positive lenses and at least one negative lens. The second lens group is constituted by one positive lens and one negative lens. The third lens group has at least two positive lenses and at least two negative lenses that include at least one cemented lens. Focusing operations are performed by only the second lens group moving.

### CROSS REFERENCE TO RELATED APPLICATIONS

The present application claims priority under 35 U.S.C. §119 to Japanese Patent Application No. 2015-052258 filed on Mar. 16, 2015. The above application is hereby expressly incorporated by reference, in its entirety, into the present application.

### BACKGROUND

The present disclosure is related to an imaging lens. More particularly, the present disclosure is related to an imaging lens which is favorably suited for use for medium telephoto imaging or telephoto imaging in imaging apparatuses such as digital cameras and the like. In addition, the present disclosure is related to an imaging apparatus equipped with such an imaging lens.

Recently, imaging lenses that adopt the inner focus method are being employed as medium telephoto imaging lenses or telephoto imaging lenses in imaging apparatuses such as digital cameras. For example, Japanese Unexamined Patent Publication Nos. 2013-033178, 2013-097212, 2014-010283, and 2014-139699 disclose imaging lenses having three group configurations constituted by a first lens group, a second lens group, and a third lens group, in which the second lens group is moved with respect to an image formation plane while the first lens group and the third lens group are fixed with respect to the image formation plane to perform focusing operations.

### SUMMARY

Meanwhile, there is increasing demand for imaging lenses to be miniaturized and for fluctuations in aberrations caused by focusing operations to be reduced in imaging lenses that adopt the inner focus method.

Here, the imaging lenses disclosed in Japanese Unexamined Patent Publication Nos. 2013-033178, 2013-097212, and 2014-010283 are constituted by, in order from the object side to the image side, a first lens group having a positive refractive power, a second lens group having a negative refractive power, and a third lens group having a positive or a negative refractive power. In these imaging lenses, an aperture stop is positioned at the image side of the second lens group, which is the focusing lens group. In the case of such a configuration, it is necessary for the aperture stop to be positioned remote from the first lens group in order to secure an amount of space in the direction of the optical axis in which the second lens group moves during focusing operations. As a result, the diameters of lenses that constitute the first lens group will increase.

In addition, in the imaging lens disclosed in Japanese Unexamined Patent Publication No. 2013-033178, the second lens group, which is the focusing lens group, is constituted by three lenses. However, such a configuration is disadvantageous from the viewpoint of miniaturizing the focusing lens group. In the imaging lens disclosed in Japanese Unexamined Patent Publication No. 2013-097212, the second lens group, which is the focusing lens group, is constituted by one lens. It is difficult for such a configuration to sufficiently suppress fluctuations in various aberrations, such as chromatic aberrations, during focusing operations.

The imaging lens disclosed in Japanese Unexamined Patent Publication No. 2014-139699 is constituted by, in order from the object side to the image side, a first lens group having a positive refractive power, a second lens group having a positive or a negative refractive power, and a third lens group having a positive refractive power. In the imaging lenses according to Examples 1, 3, 5 and 8 of Japanese Unexamined Patent Publication No. 2014-139699, the second lens group, which is the focusing lens group, is constituted by two negative lenses. In the case that the second lens group is constituted by two negative lenses, it is difficult to sufficiently suppress fluctuations in various aberrations, such as chromatic aberrations, during focusing operations. In addition, in the imaging lenses according to Examples 9 and 10 of Japanese Unexamined Patent Publication No. 2014-139699, the second lens group is constituted by one lens. Therefore, it is difficult to sufficiently correct fluctuations in aberrations caused by focusing operations. Further, in the imaging lenses according to Examples 4, 6, and 7 of Japanese Unexamined Patent Publication No. 2014-139699, the third lens group is constituted by three lenses. However, configuring an imaging lens having a third lens group that adopts such a configuration as a lens for medium telephoto imaging or as a lens for telephoto imaging is disadvantageous from the viewpoint of correcting various aberrations, such as chromatic aberrations.

The present disclosure has been developed in view of the foregoing circumstances. The present disclosure provides an imaging lens that employs the inner focus method having favorable optical performance that realizes a decrease in the diameters of lenses that constitute a first lens group, miniaturization of a second lens group, which is a focusing lens group, and a decrease in fluctuations in aberrations caused by focusing operations. The present disclosure also provides an imaging apparatus to which this imaging lens is applied.

A first imaging lens of the present disclosure consists of, in order from the object side to the image side:

a first lens group having a positive refractive power;

a second lens group having a negative refractive power; and

a third lens group having a positive refractive power;

an aperture stop being positioned at the object side of the second lens group;

the first lens group having at least two positive lenses and at least one negative lens;

the second lens group consisting of at least one positive lens and at least one negative lens;

the third lens group having at least two positive lenses and at least two negative lenses that include at least one cemented lens; and

the second lens group moving along the optical axis from the object side to the image side while the first lens group and the third lens group are fixed with respect to an image formation plane to change focus from an object at infinity to an object at a proximal distance.

In the imaging lens of the present disclosure, it is preferable for the aperture stop to be positioned between a lens surface most toward the image side within the first lens group and a lens surface most toward the object side within the second lens group, and for the aperture stop to be fixed with respect to the image formation plane during focusing operations.

In the imaging lens of the present disclosure, it is preferable for the second lens group to consist of a cemented lens formed by cementing one positive lens and one negative lens together.

In the imaging lens of the present disclosure, it is preferable for the first lens group to have at least three positive lenses and at least one negative lens.

In the imaging lens of the present disclosure, it is preferable for the first lens group to consist of at least three positive lenses and at least one negative lens.

In the imaging lens of the present disclosure, it is preferable for the third lens group to have a lens component having a negative refractive power at the most image side within the third lens group.

In the imaging lens of the present disclosure, it is preferable for the first lens group to consist of, in order from the object side to the image side, a positive lens, a positive lens, a positive lens, and a negative lens.

In the imaging lens of the present disclosure, it is preferable for the third lens group to consist of, in order from the object side to the image side, a third-group first lens group having a positive refractive power, a third-group second lens group having a positive refractive power, and a third-group third lens group having a negative refractive power, for the third-group first lens group and the third-group second lens group to be separated by one of the largest and the second largest air distances along the optical axis from among the air distances among adjacent lenses within the third lens group, and for the third-group second lens group and the third-group third lens group to be separated by the other of the largest and the second largest air distances.

In the imaging lens of the present disclosure, it is preferable for the third-group first lens group to have at least one cemented lens, for the third-group second lens group to consist of one lens component having a positive refractive power, and for the third-group third lens group to consist of one lens component having a negative refractive power.

In the imaging lens of the present disclosure, it is preferable for the third lens group to have a single lens having a negative refractive power at the most image side within the third lens group.

It is preferable for the imaging lens of the present disclosure to consist of at most twelve lenses as a whole.

In the imaging lens of the present disclosure, it is preferable for the aperture stop to be positioned at the image side of the lens surface most toward the object side within the first lens group, and for a filter, of which the transmissivity decreases as the distance from the optical axis increases, to be positioned adjacent to the aperture stop at one of the object side and the image side thereof.

In the imaging lens of the present disclosure, it is preferable for one of Conditional Formulae (1) through (7) below to be satisfied. Note that any one of Conditional Formulae (1) through (7) may be satisfied, or arbitrary combinations of Conditional Formulae (1) through (7) may be satisfied in preferred aspects of the imaging lens of the present disclosure.

58<νd_G1p2 (1)

43<νd_G1pm (2)

1.0<TL/f<1.6 (3)

0.3<|f2|/f<0.8 (4)

0.2<Bf/f<0.4 (5)

0.1<D23/TL<0.2 (6)

70<νd_G1p1 (7)

wherein νd_G1p2 is the Abbe's number with respect to the d line of at least two of the positive lenses from among the positive lenses included in the first lens group, νd_G1pm is the smallest Abbe's number among the Abbe's numbers with respect to the d line of the positive lenses included in the first lens group, TL is the distance along the optical axis from the lens surface most toward the object side within the first lens group to the image formation plane with back focus as an air converted distance, f is the focal length of the entire lens system in a state focused on an object at infinity, f2 is the focal length of the second lens group, D23 is the distance along the optical axis from the lens surface most toward the image side within the second lens group to the lens surface most toward the object side within the third lens group in a state focused on an object at infinity, Bf is the distance along the optical axis from the lens surface most toward the image side within the third lens group to the image formation plane as an air converted distance, and νd_G1p1 is the Abbe's number with respect to the d line of at least one lens from among the positive lenses included in the first lens group.

An imaging apparatus of the present disclosure is characterized by being equipped with an imaging lens of the present disclosure.

Note that the expression “consists of” above means that the imaging lens may also include lenses that practically do not have any power, optical elements other than lenses such as an aperture stop and a cover glass, and mechanical components such as lens flanges, a lens barrel, an imaging element, a camera shake correcting mechanism, etc., in addition to the constituent elements listed above.

In addition, the expression “lens component” refers to a lens having only two surfaces that contact air on the optical axis, the surface toward the object side and the surface toward the image side. One lens component refers to a single lens or a cemented lens formed by a set of lenses. In addition, the signs of the refractive powers of each lens group represent the sign of the refractive power of the lens group as a whole, and the signs of the refractive powers of each cemented lens represent the sign of the refractive power of the cemented lens as a whole.

The imaging lens that adopts the inner focus method of the present disclosure is constituted by, in order from the object side to the image side, the first lens group having a positive refractive power, the second lens group having a negative refractive power, and the third lens group having a positive refractive power. The aperture stop is positioned at the object side of the second lens group. The lens configurations of the first lens group through the third lens group as well as the position of the aperture stop are favorably set. Therefore, the imaging lenses can realize a decrease in the diameters of lenses that constitute a first lens group, miniaturization of a second lens group, which is a focusing lens group, and a decrease in fluctuations in aberrations caused by focusing operations, as well as high optical performance.

The imaging apparatus of the present disclosure is equipped with an imaging lens of the present disclosure. Therefore, the imaging apparatus can be configured to be compact, and is capable of obtaining favorably images having high resolution, in which various aberrations are corrected.

### BRIEF DESCRIPTION OF THE DRAWINGS

FIG. 1 is a sectional diagram that illustrates the lens configuration of an imaging lens according to Example 1 of the present disclosure.

FIG. 2 is a sectional diagram that illustrates the lens configuration of an imaging lens according to Example 2 of the present disclosure.

FIG. 3 is a sectional diagram that illustrates the lens configuration of an imaging lens according to Example 3 of the present disclosure.

FIG. 4 is a sectional diagram that illustrates the lens configuration of an imaging lens according to Example 4 of the present disclosure.

FIG. 5 is a sectional diagram that illustrates the lens configuration of an imaging lens according to Example 5 of the present disclosure.

FIG. 6 is a sectional diagram that illustrates the lens configuration of an imaging lens according to Example 6 of the present disclosure.

FIG. 7 is a sectional diagram that illustrates the paths of light rays that pass through the imaging lens according to Example 6 of the present disclosure.

FIG. 8 is a collection of diagrams that illustrate various aberrations of the imaging lens according to Example 1, which are spherical aberration, offense against the sine condition, astigmatism, distortion, and lateral chromatic aberration in this order from the left side of the drawing sheet.

FIG. 9 is a collection of diagrams that illustrate various aberrations of the imaging lens according to Example 2, which are spherical aberration, offense against the sine condition, astigmatism, distortion, and lateral chromatic aberration in this order from the left side of the drawing sheet.

FIG. 10 is a collection of diagrams that illustrate various aberrations of the imaging lens according to Example 3, which are spherical aberration, offense against the sine condition, astigmatism, distortion, and lateral chromatic aberration in this order from the left side of the drawing sheet.

FIG. 11 is a collection of diagrams that illustrate various aberrations of the imaging lens according to Example 4, which are spherical aberration, offense against the sine condition, astigmatism, distortion, and lateral chromatic aberration in this order from the left side of the drawing sheet.

FIG. 12 is a collection of diagrams that illustrate various aberrations of the imaging lens according to Example 5, which are spherical aberration, offense against the sine condition, astigmatism, distortion, and lateral chromatic aberration in this order from the left side of the drawing sheet.

FIG. 13 is a collection of diagrams that illustrate various aberrations of the imaging lens according to Example 6, which are spherical aberration, offense against the sine condition, astigmatism, distortion, and lateral chromatic aberration in this order from the left side of the drawing sheet.

FIG. 14A is a perspective view that illustrates the front side of an imaging apparatus according to an embodiment of the present disclosure.

FIG. 14B is a perspective view that illustrates the rear side of an imaging apparatus according to an embodiment of the present disclosure.

### DETAILED DESCRIPTION OF THE PREFERRED EMBODIMENTS

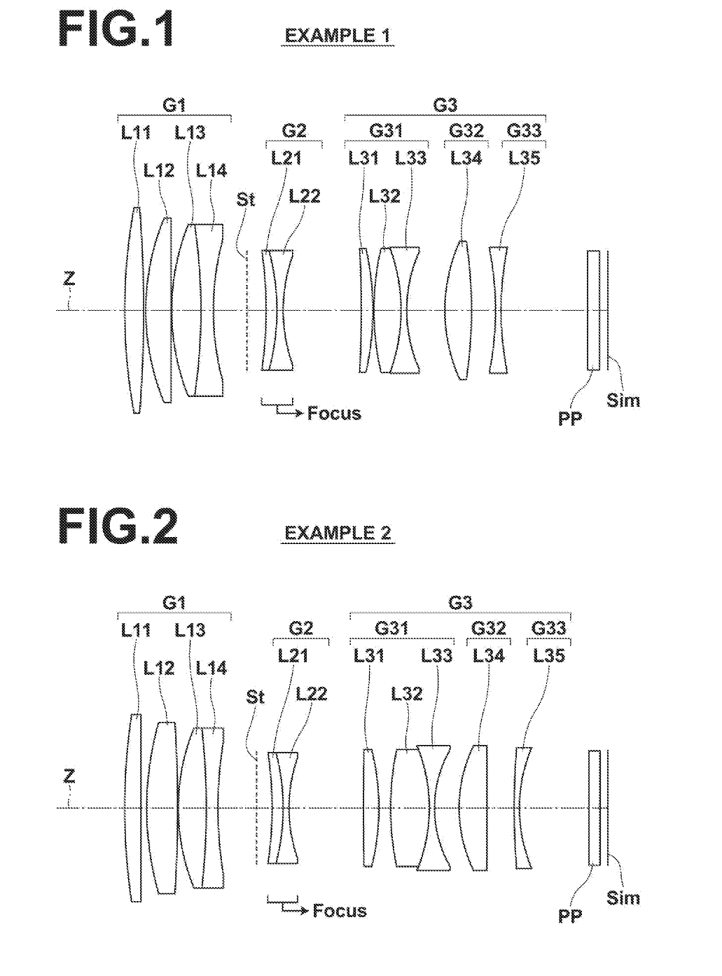

Hereinafter, embodiments of the present disclosure will be described in detail with reference to the attached drawings. FIG. 1 is a cross sectional diagram that illustrate the configurations of an imaging lens according to an embodiment of the present disclosure that corresponds to an imaging lens of Example 1 to be described later. In addition, FIG. 2 through FIG. 6 are cross sectional diagrams that illustrate other examples of configurations according to embodiments of the present disclosure, and respectively correspond to imaging lenses of Examples 2 through 6 to be described later. The basic configurations of the Examples illustrated in FIG. 1 through FIG. 6 are the same except for the number of lenses in each of three lens groups, and the manners in which the configurations are illustrated are the same. Therefore, the imaging lenses according to the embodiments of the present disclosure will be described mainly with reference to FIG. 1.

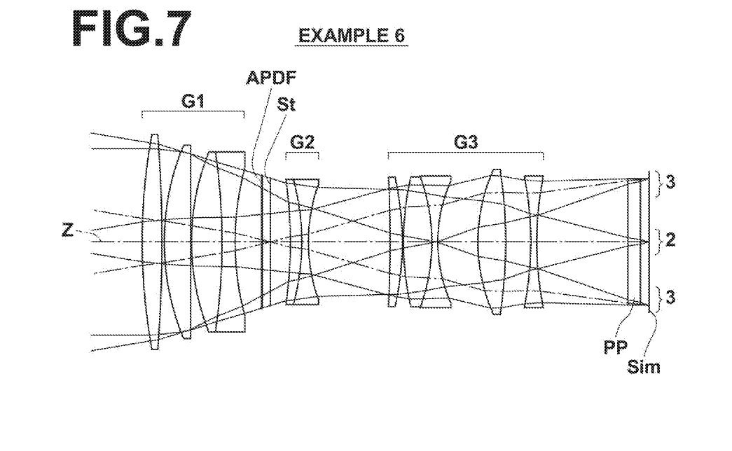

FIG. 1 illustrates the arrangement of the optical system in a state focused on an object at infinity, with the left side as the object side and the right side as the image side. The same applies to FIG. 2 through FIG. 6 to be described later. In addition, FIG. 7 is a cross sectional diagram that illustrates the paths of an axial light beam 2 from an object at infinity and a light beam 3 at a maximum angle of view that pass through the imaging lens according to Example 6.

The imaging lens 1 of the present embodiment is constituted by: a first lens group G1 having a positive refractive power, a second lens group G2 having a negative refractive power, and a third lens group G3 having a positive refractive power, as lens groups provided in order from the object side to the image side. In the example illustrated in FIG. 1, the first lens group G1 is constituted by four lenses, which are lenses L11 through L14, provided in this order from the object side. The second lens group G2 is constituted by two lenses, which are a lens L21 and a lens L22, provided in this order from the object side. The third lens group G3 is constituted by five lenses, which are lenses L31 through L35, provided in this order from the object side.

The imaging lens is a fixed focal point type optical system that employs the inner focus method, in which the second lens group G2 is moved along an optical axis Z from the object side to the image side while the first lens group G1 and the third lens group G3 are fixed with respect to an image formation plane Sim, to change focus from an object at infinity to an object at a proximal distance. By configuring the imaging lens 1 such that only the second lens group G2 is moved during focusing operations, a focusing unit that moves components during focusing operations can be formed to be compact and lightweight. Such a configuration is advantageous from the viewpoints of decreasing the load on a drive system and increasing the speed of focusing operations. In addition, the first lens group G1 and the third lens group G3 are fixed with respect to the image formation plane Sim. As a result, superior dust preventing properties can be secured.

In addition, the imaging lens 1 is equipped with an aperture stop St which is positioned at the object side of the second lens group G2, which is the focusing lens group. By positioning the aperture stop St at the object side of the second lens group G2 in this manner, the diameters of the lenses within the first lens group G1 and the second lens group G2 can be decreased. In addition, such a configuration facilitates securing space for movement of the second lens group G2 in the direction of the optical axis during focusing operations. Therefore, this configuration is advantageous from the viewpoint of shortening the most proximal imaging distance. In addition, the imaging lens 1 consists of, in order from the object side to the image side: the first lens group G1 having a positive refractive power, the second lens group G2 having a negative refractive power, and the third lens group G3 having a positive refractive power, and the aperture stop St is positioned at the object side o the second lens group G2. By adopting this configuration, distortion can be favorably corrected.

Note that the aperture stop St illustrated in FIG. 1 does not necessarily represent the size or the shape thereof, but the position thereof along the optical axis Z. In addition, Sim illustrated in FIG. 1 is the image formation plane. An imaging element such as a CCD (Charge Coupled Device) and a CMOS (Complementary Metal Oxide Semiconductor) is provided at this position as will be described later.

In addition, it is preferable for the aperture stop St to be positioned between the lens surface most toward the image side within the first lens group G1 and the lens surface most toward the object side within the second lens group G2, and to be fixed with respect to the image formation plane Sim during focusing operations. In this case, the aperture stop St will not be moved with respect to the image formation plane Sim during focusing operations, and the focusing unit for moving components during focusing operations can be formed to be compact and lightweight. Such a configuration is advantageous from the viewpoints of decreasing the load on a drive system can be reduced and increasing the speed of focusing operations. In addition, this configuration can simplify the configuration of a lens holding frame of the first lens group G1 compared to a case in which the aperture stop St is positioned between the lens surface most toward the object side within the first lens group G1 and the lens surface most toward the image side within the first lens group G1, and can suppress the generation of eccentricities among each of the lenses which are included in the first lens group G1.

The first lens group G1 has a positive refractive as a whole. In addition, the first lens group G1 is configured to have at least two positive lenses and at least one negative lens. By the first lens group being configured in this manner, miniaturization of the imaging lens 1 can be achieved, while spherical aberration and longitudinal chromatic aberration can be favorably corrected.

It is preferable for the first lens group G1 to have at least three positive lenses and at least one negative lens. In this case, the refractive power of each of the positive lenses can be prevented from becoming excessively strong because the first lens group G1 has at least three positive lenses, which is advantageous from the viewpoints of correcting spherical aberration and comatic aberration. In addition, the first lens group G1 has at least one negative lens. This configuration is advantageous from the viewpoints of correcting spherical aberration and longitudinal chromatic aberration.

Further, it is more preferable for the first lens group G1 to consist of three positive lenses and one negative lens. By the first lens group G1 being of a four lens configuration constituted by three positive lenses and one negative lens, aberrations can be favorably corrected and optical performance can be secured, while suppressing increases in the diameters and the thicknesses in the direction of the optical axis of each lens which is included in the first lens group G1, compared to a case in which the number of lenses which are included in the first lens group G1 is increased further.

Further, it is even more preferable for the first lens group G1 to consist of, in order from the object side to the image side: a positive lens L11, a positive lens L12, a positive lens L13, and a negative lens L14. In this case, a light beam converging effect can be increased compared to a case in which three positive lenses L11 through L13 are continuously positioned in order from the object side to the image side. In addition, by distributing the positive refractive power of the first lens group G1 among the three positive lenses L11 through L13, the positive refractive powers of each of the positive lenses can be prevented from becoming excessively strong. In addition, by positioning one negative lens L14 most toward the image side within the first lens group G1, spherical aberration, comatic aberration, and chromatic aberration can be favorably corrected.

The second lens group G2 has a negative refractive power as a whole. In addition, the second lens group G2 consists of one positive lens and one negative lens. For this reason, fluctuations in chromatic aberration caused by focusing operations can be favorably suppressed. In addition, fluctuations in chromatic aberration caused by focusing operations can be favorably suppressed, while achieving miniaturization and weight reduction of the second lens group. As a result, this configuration is advantageous from the viewpoints of decreasing the load on a drive system and increasing the speed of focusing operations. In order to obtain these advantageous effects, the second lens group G2 may be constituted by, in order from the object side to the image side, a positive lens and a negative lens, or constituted by, in order from the object side to the image side, a negative lens and a positive lens.

Further, it is preferable for the second lens group G2 to be constituted by one cemented lens formed by cementing one positive lens and one negative lens together. In this case, chromatic aberration can be favorably corrected. In addition, in the case that the second lens group G2 is constituted by one cemented lens, the configuration of a lens holding frame of the second lens group G2 can be simplified, which is advantageous from the viewpoint of reducing the weight of a focusing unit. In addition, the cemented lens that constitutes the second lens group G2 may be a cemented lens formed by cementing a positive lens and a negative lens, provided in this order from the object side to the image side, together, or a cemented lens formed by cementing a negative lens and a positive lens, provided in this order from the object side to the image side, together.

The third lens group G3 has a positive refractive power as a whole. In addition, third lens group G3 has at least two positive lenses and at least two negative lenses. By the third lens group G3 having at least two negative lenses, it will be possible to position the at least two negative lenses at different positions along the optical axis. For this reason, axial aberrations and off axis aberrations can be corrected with favorable balance. In addition, by positioning at least two positive lenses having positive refractive powers at different positions along the optical axis, axial aberrations can be corrected at positions where the difference between the heights of axial light rays and the heights of off axis light rays is relatively small, while off axis aberrations can be corrected at positions where the difference between the heights of axial light rays and the heights of off axis light rays is relatively great. Therefore, axial aberrations and off axis aberrations can be corrected with favorable balance.

Here, the third lens group G3 is positioned more toward the image side than the second lens group G2, which is the focusing lens group. Therefore, the third lens group G3 is at a position remote from the aperture stop St. It is preferable for the third lens group G3 to include at least one cemented lens. In addition, in the case that the third lens group G3 has at least two positive lenses and at least two negative lenses that include at least one cemented lens, various axial aberrations and various off axis aberrations such as distortion can be favorably corrected at the third lens group G3, even in a state in which the third lens group G3 is provided at a position remote from the aperture stop St.

Further, it is preferable for the third lens group G3 to have at least two positive lenses and at least two negative lenses, and for the third lens group G3 as a whole to consist of at most five lenses. In this case, axial aberrations and off axis aberrations such as distortion can be favorably corrected, while realizing miniaturization, weight reduction, and cost reduction. Note that the imaging lenses illustrated in FIGS. 1 through 3, 5, and 6 are examples of configurations in which the third lens group G3 has at least two positive lenses and at least two negative lenses, and consists of at most five lenses as a whole.

For example, the at least one cemented lens which is included in the third lens group G3 may be a cemented lens having a two lens configuration in which two adjacent lenses are cemented together, or a cemented lens having a three lens configuration in which three adjacent lenses are cemented together in order in the direction of the optical axis. In addition, it is preferable for the cemented lens which is included in the third lens group G3 to be a cemented lens that includes at least one positive lens and at least one negative lens.

In the imaging lens 1, it is preferable for the third lens group G3 to have a lens component having a negative refractive power provided most toward the image side within the third lens group G3. In this case, off axis light rays can be directed in a direction away from the optical axis, and the total length of the lens system can be shortened. In addition, it is more preferable for the third lens group G3 to have a single lens having a negative refractive power provided most toward the image side within the third lens group G3. In this case, securing a negative refractive power at the most image side within the third lens group G3 is facilitated, and the length of the third lens group G3 along the optical axis can be more favorably shortened. In addition, the third lens group can be formed to be more compact and lightweight.

It is preferable for the third lens group G3 to have a single lens having a negative refractive power at the most image side within the third lens group, and a single lens having a positive refractive power positioned adjacent to the single lens having a negative refractive power at the object side thereof. In this case, off axis aberrations, particularly field curvature can be favorably corrected.

The third lens group G3 may consist of, in order from the object side to the image side, a third-group first lens group G31 having a positive refractive power, a third-group second lens group G32 having a positive refractive power, and a third-group third lens group G33 having a negative refractive power. Note that in this case, the third-group first lens group G31 and the third-group second lens group G32 are separated by one of the largest and the second largest air distances along the optical axis from among the air distances among adjacent lenses within the third lens group G3, and the third-group second lens group G32 and the third-group third lens group G33 are separated by the other of the largest and the second largest air distances.

The third lens group G3 has, in order from the object side to the image side, the third-group first lens group G31 having a positive refractive power and the third-group second lens group G32 having a positive refractive power. Therefore, positive refractive power necessary to miniaturize the third lens group G3 can be increased, while the positive refractive power is distributed between two lens groups, in order to enable favorable correction of aberrations. In addition, by positioning the third-group first lens group G31 having a positive refractive power and the third-group second lens group G32 having a positive refractive power in this order from the object side to the image side, axial aberrations can be corrected at positions where the difference between the heights of axial light rays and the heights of off axis light rays is relatively small, while off axis aberrations can be corrected at positions where the difference between the heights of axial light rays and the heights of off axis light rays is relatively great. Therefore, axial aberrations and off axis aberrations can be corrected with favorable balance. In addition, the third lens group G3 has the third-group third lens group G33 having a negative refractive power provided most toward the image side therein. Therefore, off axis light rays can be directed in a direction away from the optical axis, and the total length of the lens system can be shortened.

In addition, in the case that the third lens group G3 consists of the third-group first lens group G31, the third-group second lens group G32, and the third-group third lens group G33, it is preferable for the third-group first lens group G31 to have at least one cemented lens. Chromatic aberrations can be favorably corrected, by the third-group first lens group G31 having at least one cemented lens. For example, the cemented lens included in the third-group first lens group G31 may be a cemented lens formed by cementing one positive lens and one negative lens together.

In addition, it is preferable for the third-group second lens group G32 to consist of one lens component that has a positive refractive power. In this case, miniaturization of the third-group second lens group G32 can be achieved. Further, in the case that the third-group second lens group G32 consists of one lens component that has a positive refractive power, a securing a necessary amount of positive refractive power is facilitated, and the third lens group G3 can be formed to be more compact and lightweight.

In addition, it is preferable for the third-group third lens group G33 to consist of one lens component that has a negative refractive power. In this case, miniaturization of the third-group third lens group G33 can be achieved. Further, it is more preferable for the third-group third lens group G33 to consist of one single lens having a negative refractive power. In this case, the lens provided most toward the image side within the third lens group G3 will be a single lens. As a result, securing negative refractive power at the most image side of the third lens group G3 will be facilitated, and the length along the optical axis of the third lens group G3 can be more favorably shortened. In addition, the third lens group G3 can be formed to be more compact and lightweight.

The imaging lenses illustrated in FIGS. 1 through 3 and 6 are examples of configurations in which the third-group first lens group G31 has a cemented lens formed by cementing a lens L32 and a lens L33 together, the third-group second lens group G32 is constituted by one positive lens L34, and the third-group third lens group G33 is constituted by one negative lens L35.

In addition, FIG. 1 illustrates an example in which a parallel plate shaped optical member PP is provided between the third lens group G3 and the image formation plane Sim. When an imaging lens is applied to an imaging apparatus, it is often the case that a cover glass and various types of filters, such as an infrared cutoff filter and a low pass filter, are provided between the imaging lens and the image formation plane Sim. The optical member PP assumes the presence of such elements.

Although not illustrated in FIG. 1, the imaging lens 1 may further be equipped with a so called APD filter (Apodization Filter), of which the transmissivity decreases as the distance from the optical axis increases. In this case, it is preferable for the aperture stop St to be positioned at the image side of the lens surface most toward the object side within the first lens group G1, and for the APD filter APDF to be provided adjacent to the aperture stop St at the object side or the image side thereof. By positioning the APD filter APDF adjacent to the aperture stop St, the amount of light that passes through the APD filter can be decreased depending on distances from the optical axis at a position in the vicinity of the aperture stop St. This configuration contributes to the formation of smooth blurred images. Note that FIG. 6 illustrates an example of a configuration equipped with the APD filter APDF, having the same basic lens configuration as the imaging lens 1 of FIG. 1.

In addition, the imaging lens 1 may be of a configuration in which the APD filter APDF is always included, or a configuration in which the APD filter APDF is removably provided. In the case that the imaging lens 1 is of a configuration in which the APD filter APDF is removably provided, it is necessary to correct the focus position prior to and following insertion and removal of the APD filter APDF. Correction of the focus position may be performed by moving the imaging lens 1 relative to the image formation plane Sim. However, it is simpler to correct the focus position by moving the second lens group G2, which is the focusing lens group, and therefore adopting this configuration is more preferable.

In addition, it is preferable for the configurations of the imaging lens 1 to be generalized as much as possible regardless of the presence of the APD filter APDF, from the viewpoint of productivity. Similarly, it is preferable for other components, such as mechanical components, of the imaging apparatus equipped with the imaging lens 1 to be generalized as much as possible regardless of the presence of the APD filter APDF. In order to generalize the configurations of the imaging lens 1 or the imaging apparatus in this manner, it is necessary to correct the focus position prior to and after insertion and removal of the APD filter APDF. When correcting the focus position, it is preferable for correction of the focus position to be performed by moving the second lens group G2 in the case that there is sufficient space to move the second lens group G2 along the optical axis for focusing operations and the displacement of the focus position is small. Alternatively, in the case that it is not possible to correct the focus position by movement of the second lens group G2 or in the case that fluctuations in aberrations which are caused by inserting the APD filter APDF are great, correcting the focus position by changing a portion of the lens configuration of the imaging lens 1 may be considered.

It is preferable for the imaging lens to consist of at most twelve lenses. In this case, miniaturization and a reduction in weight of the imaging lens 1 can be realized.

The imaging lens 1 of the present embodiment consists of, in order from the object side to the image side: the first lens group G1 having a positive refractive power, the second lens group G2 having a negative refractive power, and the third lens group G3 having a positive refractive power. The aperture stop St is positioned at the object side of the second lens group G2. The lens configurations of the first lens group G1 through the third lens group G3 as well as the position of the aperture stop St are favorably set. Therefore, a decrease in the diameters of the lenses within the first lens group G1, miniaturization of the second lens group G2, which is the focusing lens group, a decrease in fluctuations in aberrations caused by focusing operations, and high optical performance can be realized.

The imaging lens 1 is of the configuration described above. In addition, Conditional Formula (1) below is satisfied.

58<νd_G1p2 (1)

wherein νd_G1p2 is the Abbe's number with respect to the d line of at least two positive lenses from among the positive lenses which are included in the first lens group G1.

It is preferable for the positive lenses within the first lens group G1, in which the diameter of an axial light beam is greatest, to be formed by a low dispersion material in order to favorably correct chromatic aberration and other various aberrations. By configuring the imaging lens 1 such that the value of νd_G1p2 is not less than or equal to the lower limit defined in Conditional Formula (1), longitudinal chromatic aberration can be favorably corrected. In addition, it is more preferable for Conditional Formula (1-1) to be satisfied. Configuring the imaging lens 1 such that the value of νd_G1p2 is not greater than or equal to the upper limit defined in Conditional Formula (1-1) is advantageous from the viewpoint of securing a necessary amount of refractive power and correcting various aberrations such as spherical aberration. It is more preferable for Conditional Formula (1-2) to be satisfied, in order to cause the advantageous effects obtained by Conditional Formula (1-1) being satisfied to become more prominent.

58<νd_G1p2<100 (1-1)

58<νd_G1p2<90 (1-2).

In addition, it is preferable for Conditional Formula (2) below to be satisfied in the imaging lens 1.

43<νd_G1pm (2)

wherein νd_G1pm is the smallest Abbe's number among the Abbe's numbers with respect to the d line of the positive lenses included in the first lens group G1.

By configuring the imaging lens 1 such that the value of νd_G1pm is not less than or equal to the lower limit defined in Conditional Formula (2), the positive lenses of the first lens group, in which the diameter of an axial light beam is the greatest, can be formed by a low dispersion material, and longitudinal chromatic aberration can be favorably corrected. In addition, by configuring the imaging lens 1 such that the value of νd_G1pm is not greater than or equal to the upper limit defined in Conditional Formula (2-1), a necessary refractive index can be secured, which is advantageous from the viewpoint of favorably corrected various aberrations, such as spherical aberration. It is more preferable for Conditional Formula (2-2) to be satisfied, in order to cause the advantageous effects obtained by Conditional Formula (2-1) being satisfied to become more prominent.

43<νd_G1pm<100 (2-1)

45<νd_G1pm<100 (2-2).

In addition, it is preferable for Conditional Formula (3) below to be satisfied in the imaging lens 1.

1.0<TL/f<1.6 (3)

wherein TL is the distance along the optical axis from the lens surface most toward the object side within the first lens group G1 to the image formation plane with back focus as an air converted distance, and f is the focal length of the entire lens system in a state focused on an object at infinity.

By configuring the imaging lens 1 such that the value of TL/f is not less than or equal to the lower limit defined in Conditional Formula (3), various aberrations can be favorably corrected. By configuring the imaging lens 1 such that the value of TL/f is not greater than or equal to the upper limit defined in Conditional Formula (3), the total length of the entire imaging lens 1 can be shortened. For this reason, adopting such a configuration is advantageous from the viewpoint of improving the portability of an imaging apparatus equipped with the imaging lens 1. It is more preferable for Conditional Formula (3-1) to be satisfied, in order to cause the advantageous effects obtained by Conditional Formula (3) being satisfied to become more prominent.

1.15<TL/f<1.50 (3-1).

In addition, it is preferable for Conditional Formula (4) below to be satisfied in the imaging lens 1.

0.3<|f2|/f<0.8 (4)

wherein f is the focal length of the entire lens system in a state focused on an object at infinity, and f2 is the focal length of the second lens group G2.

By configuring the imaging lens 1 such that the value of |f2|/f is not less than or equal to the lower limit defined in Conditional Formula (4), the refractive power of the second lens group G2 can be prevented from becoming excessively strong. Therefore, increases in fluctuations in comatic aberration and chromatic aberrations caused by focusing operations can be suppressed, and favorable optical performance can be obtained even when imaging at proximal distances. By configuring the imaging lens 1 such that the value of |f2|/f is not greater than or equal to the upper limit defined in Conditional Formula (4), the refractive power of the second lens group G2 can be prevented from becoming excessively weak. Therefore, an increase in the amount of movement of the second lens group G2 during focusing operations can be favorably suppressed, which is advantageous from the viewpoints of increasing the speed of focusing operations and shortening the total length of the lens system. It is more preferable for Conditional Formula (4-1) to be satisfied, in order to cause the advantageous effects obtained by Conditional Formula (4) being satisfied to become more prominent.

0.4<|f2|/f<0.7 (4-1).

In addition, it is preferable for Conditional Formula (5) below to be satisfied in the imaging lens 1.

0.2<Bf/f<0.4 (5)

wherein Bf is the distance along the optical axis from the lens surface most toward the image side within the third lens group G3 to the image formation plane as an air converted distance, and f is the focal length of the entire lens system in a state focused on an object at infinity.

By configuring the imaging lens such that the value of Bf/f is not less than or equal to the lower limit defined in Conditional Formula (5), a necessary amount of back focus, which is particularly necessary in interchangeable lenses, can be secured. Configuring the imaging lens such that the value of Bf/f is not greater than or equal to the upper limit defined in Conditional Formula (5) is advantageous from the viewpoint of shortening the total length of the lens system. It is more preferable for Conditional Formula (5-1) to be satisfied, in order to cause the advantageous effects obtained by Conditional Formula (5) being satisfied to become more prominent.

0.23<Bf/f<0.37 (5-1).

In addition, it is preferable for Conditional Formula (6) below to be satisfied in the imaging lens 1.

0.1<D23/TL<0.2 (6)

wherein D23 is the distance along the optical axis from the lens surface most toward the image side within the second lens group G2 to the lens surface most toward the object side within the third lens group G3 in a state focused on an object at infinity, and TL is the distance along the optical axis from the lens surface most toward the object side within the first lens group G1 to the image formation plane with back focus as an air converted distance.

By configuring the imaging lens 1 such that the value of D23/TL is not less than or equal to the lower limit defined in Conditional Formula (6), space for movement of the second lens group G2 in the direction of the optical axis during focusing operations can be secured. Therefore, this configuration is advantageous from the viewpoint of shortening the most proximal imaging distance. In the case that the value of D23/TL is less than or equal to the lower limit defined in Conditional Formula (6), it will become necessary to increase the refractive power of the second lens group G2 in order to secure a short most proximal imaging distance according to demand. Therefore, a problem of fluctuations in comatic aberration and chromatic aberrations being generated by focusing operations will become likely to arise. However, the generation of this problem can be suppressed by configuring the imaging lens 1 such that the value of D23/TL is not less than or equal to the lower limit defined in Conditional Formula (6), and favorable optical performance can be obtained even when imaging at a most proximal distance. By configuring the imaging lens 1 such that the value of D23/TL is not greater than or equal to the upper limit defined in Conditional Formula (6), securing a necessary amount of back focus is facilitated even in the case that the total length of the lens system is shortened. As a result, securing a sufficient amount of space to provide the first lens group G1 and the third lens group G3 is facilitated. It is more preferable for Conditional Formula (6-1) to be satisfied, in order to cause the advantageous effects obtained by Conditional Formula (6) being satisfied to become more prominent.

0.12<D23/TL<0.18 (6-1).

In addition, it is preferable for Conditional Formula (7) below to be satisfied in the imaging lens 1.

70<νd_G1p1 (7)

wherein νd_G1p1 is the Abbe's number with respect to the d line of at least one lens from among the positive lenses included in the first lens group G1.

By configuring the imaging lens 1 such that the value of νd_G1p1 is not less than or equal to the lower limit defined in Conditional Formula (7), the positive lenses of the first lens group, in which the diameter of an axial light beam is the greatest, can be formed by a low dispersion material, and longitudinal chromatic aberration can be favorably corrected. It is more preferable for Conditional Formula (7-1) below to be satisfied, in order to cause this advantageous effect to become more prominent. In addition, it is preferable for the imaging lens 1 to be configured such that the value of νd_G1p1 is not greater than or equal to the upper limit defined in Conditional Formula (7-2). In this case, a necessary refractive index can be secured, which is advantageous from the viewpoint of favorably correcting various aberrations, such as spherical aberration.

72<νd_G1p1 (7-1)

72<νd_G1p1<100 (7-2).

Note that the imaging lens of the present disclosure may selectively be one of the aforementioned preferred configurations or an arbitrary combination thereof, as appropriate. In addition, although not illustrated in FIGS. 1 through 6, the imaging lens of the present disclosure may be provided with a light shielding means for suppressing the generation of flare, as well as various types of filters positioned between the lens system and the image formation plane Sim.

Next, examples of the imaging lens 1 of the present disclosure, and particularly examples of the numerical values thereof, will be described.

### EXAMPLE 1

The arrangement of lens groups in an imaging lens of Example 1 is illustrated in FIG. 1. Note that detailed descriptions of the lens groups and each of the lenses illustrated in FIG. 1 have already been given, and therefore redundant descriptions will be omitted here insofar as they are not particularly necessary.

Table 1 shows basic lens data of the imaging lens of Example 1. Here, the optical member PP is also included in Table 1. In the basic lens data of Table 1, ith (i=1, 2, 3, . . . ) lens surface numbers that sequentially increase from the object side to the image side, with the lens surface at the most object side designated as first, are shown in the column Si. The radii of curvature of ith surfaces are shown in the column Ri, the distances between an ith surface and an i+1st surface along the optical axis Z are shown in the column Di. The refractive indices of jth (j=1, 2, 3, . . . ) constituent elements that sequentially increase from the object side to the image side, with the lens at the most object side designated as first, with respect to the d line (wavelength: 587.6 nm) are shown in the column Ndj. The Abbe's numbers of the jth constituent element with respect to the d line are shown in the column νdj. θgFj shows the partial dispersion ratios of jth constituent elements. In addition, the basic lens data also includes the aperture stop St. The mark “∞” is shown in the column of the radius of curvature for the surface that corresponds to the aperture stop St. The signs of the radii of curvature are positive in cases that the surface shape is convex toward the object side, and negative in cases that the surface shape is convex toward the image side.

Note that the partial dispersion ratio θgFj is represented by the formula below:

θgFj=(ngj−nFj)/(nFj−nCj)

wherein ngj is the refractive index of a jth optical element with respect to the g line (wavelength: 435.8 nm), nFj is the refractive index of the jth optical element with respect to the F line (wavelength: 486.1 nm), and nCj is the refractive index of the jth optical element with respect to the C line (wavelength: 656.3 nm).

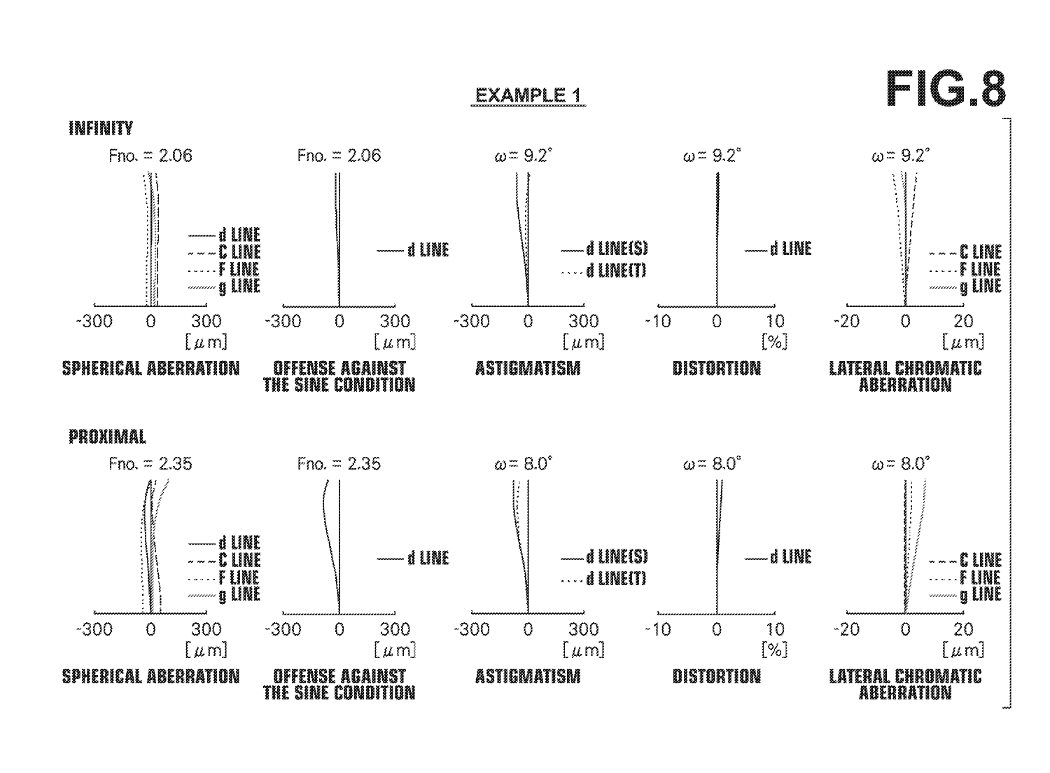

Table 2 shows values of the focal length f and the back focus Bf when focused on infinity, as well as the F number (FNo.), the full angle of view 2ω, a transverse magnification rate β, and distances among moving surfaces at each of a state focused on infinity and a state focused on a most proximal distance, as various items of data of the imaging lens of Example 1. The value of the back focus Bf is an air converted distance, the units of the full angle of view are degrees, and the units of the distances among surfaces that vary due to focusing operations are mm. FIG. 8 is a collection of diagrams that illustrate aberrations of the imaging lens of Example 1.

In addition, Table 14 to be shown later shows values corresponding to Conditional Formula (1) through (7) for each of the imaging lenses of Examples 1 through 6. Note that in Table 14, the lenses which are included in the first lens group are denoted as L11, L12, and L13, in this order from the object side to the image side.

As described above, in each of the tables below, degrees are used as units of angles, and mm are used as the units for lengths. However, it is possible for optical systems to be proportionately enlarged or proportionately reduced and utilized. Therefore, other appropriate units may be used. In addition, the tables below show numerical values which are rounded off at a predetermined number of digits. Further, the meanings of the symbols, the units of the symbols, and the manners in which the symbols are shown in the tables related to Example 1 are the same in each of the tables to be shown later related to Examples 2 through 6.

TABLE 1
Example 1

| Si | Ri | Di | Ndj | νdj | θgFj |
|---|---|---|---|---|---|
| 1 | 134.54219 | 4.550 | 1.51633 | 64.14 | 0.53531 |
| 2 | −308.48240 | 0.520 | | | |
| 3 | 57.11452 | 6.050 | 1.49700 | 81.61 | 0.53887 |
| 4 | ∞ | 0.180 | | | |
| 5 | 54.95203 | 7.010 | 1.59522 | 67.73 | 0.54426 |
| 6 | −138.92000 | 3.000 | 1.74950 | 35.33 | 0.58189 |
| 7 | 65.12954 | 8.050 | | | |
| 8 (St) | ∞ | DD [8] | | | |
| 9 | −99.96703 | 2.610 | 1.92286 | 18.90 | 0.64960 |
| 10 | −53.99500 | 1.490 | 1.63854 | 55.38 | 0.54858 |
| 11 | 38.38332 | DD [11] | | | |
| 12 | −299.93361 | 2.800 | 1.59522 | 67.73 | 0.54426 |
| 13 | −65.51447 | 0.250 | | | |
| 14 | 65.03027 | 6.510 | 1.83481 | 42.72 | 0.56486 |
| 15 | −43.00300 | 1.350 | 1.67270 | 32.10 | 0.59891 |
| 16 | 33.75440 | 9.180 | | | |
| 17 | 39.82254 | 6.400 | 1.71300 | 53.87 | 0.54587 |
| 18 | −107.03524 | 5.750 | | | |
| 19 | −75.17060 | 1.350 | 1.51742 | 52.43 | 0.55649 |
| 20 | 75.17060 | 20.784 | | | |
| 21 | ∞ | 2.850 | 1.51633 | 64.14 | 0.53531 |
| 22 | ∞ | | | | |

TABLE 2
Example 1

| | Infinity | Proximal |
|---|---|---|
| f | 87.495 | |
| Bf | 24.663 | |
| FNo. | 2.06 | 2.35 |
| 2ω | 18.4 | 16.0 |
| β | 0.00 | 0.14 |
| DD [8] | 4.600 | 12.696 |
| DD [11] | 18.753 | 10.657 |

Diagrams that illustrate the spherical aberration, the offense against the sine condition, the astigmatism, the distortion, and the lateral chromatic aberration of the imaging lens of Example 1 are shown in this order from the left side of the drawing sheet in FIG. 8. The diagrams that illustrate each of the aberrations show aberrations using the d line (wavelength: 587.6 nm) as a reference wavelength. The diagrams that illustrate spherical aberration also show aberrations related to a wavelength of 656.3 nm (the C line), a wavelength of 486.1 nm (the F line), and a wavelength of 435.8 nm (the g line). In the diagrams that illustrate astigmatism, aberrations in the sagittal direction are indicated by a solid line, while aberrations in the tangential direction are indicated by a broken line. In the diagrams that illustrate lateral chromatic aberration also show aberrations related to the C line, the F line, and the g line. In the diagrams that illustrate spherical aberrations, “FNo.” denotes F numbers. In the other diagrams that illustrate the aberrations, ω denotes half angles of view. The meanings of the symbols, the units of the symbols, and the manner in which the data are shown in the FIG. 8 are the same for the diagrams that illustrate aberrations related to Examples 2 through 6 to be described later.

### EXAMPLE 2

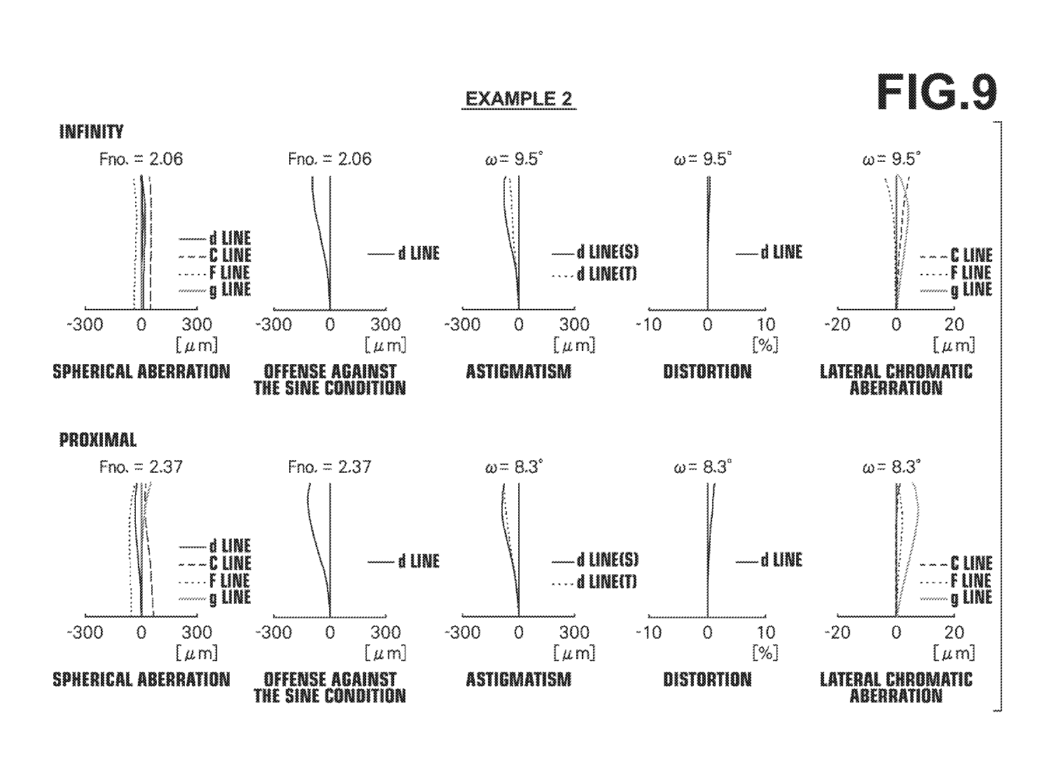

FIG. 2 illustrates the arrangement of lens groups in the imaging lens of Example 2. Tables 3 and 4 show basic lens data and various items of data for the imaging lens of Example 2, respectively. In addition, FIG. 9 shows diagrams that illustrate aberrations of the imaging lens of Example 2.

TABLE 3
Example 2

| Si | Ri | Di | Ndj | νdj | θgFj |
|---|---|---|---|---|---|
| 1 | 161.39134 | 4.200 | 1.51633 | 64.14 | 0.53531 |
| 2 | 18334.01582 | 1.500 | | | |
| 3 | 79.87877 | 8.000 | 1.49700 | 81.61 | 0.53887 |
| 4 | −334.84103 | 0.150 | | | |
| 5 | 53.69107 | 7.260 | 1.53775 | 74.70 | 0.53936 |
| 6 | −181.44026 | 3.000 | 1.73800 | 32.26 | 0.58995 |
| 7 | 104.94116 | 10.000 | | | |
| 8 (St) | ∞ | DD [8] | | | |
| 9 | −93.44318 | 2.860 | 1.92286 | 20.88 | 0.63900 |
| 10 | −55.16805 | 1.500 | 1.59522 | 67.73 | 0.54426 |
| 11 | 39.06673 | DD [11] | | | |
| 12 | 693.40515 | 4.000 | 1.53775 | 74.70 | 0.53936 |
| 13 | −59.94664 | 3.000 | | | |
| 14 | 72.00740 | 10.010 | 1.80400 | 46.58 | 0.55730 |
| 15 | −41.87081 | 1.350 | 1.67270 | 32.10 | 0.59891 |
| 16 | 30.01643 | 6.349 | | | |
| 17 | 36.10244 | 7.200 | 1.80400 | 46.58 | 0.5573 |
| 18 | −2613.83832 | 7.038 | | | |
| 19 | 195.53579 | 1.350 | 1.51633 | 64.14 | 0.53531 |
| 20 | 39.48731 | 18.000 | | | |
| 21 | ∞ | 2.850 | 1.51633 | 64.14 | 0.53531 |
| 22 | ∞ | | | | |

TABLE 4
Example 2

| | Infinity | Proximal |
|---|---|---|
| f | 87.029 | |
| Bf | 21.880 | |
| FNo. | 2.06 | 2.37 |
| 2ω | 19.0 | 16.6 |
| β | 0.00 | 0.14 |
| DD [8] | 4.000 | 12.982 |
| DD [11] | 19.250 | 10.268 |

### EXAMPLE 3

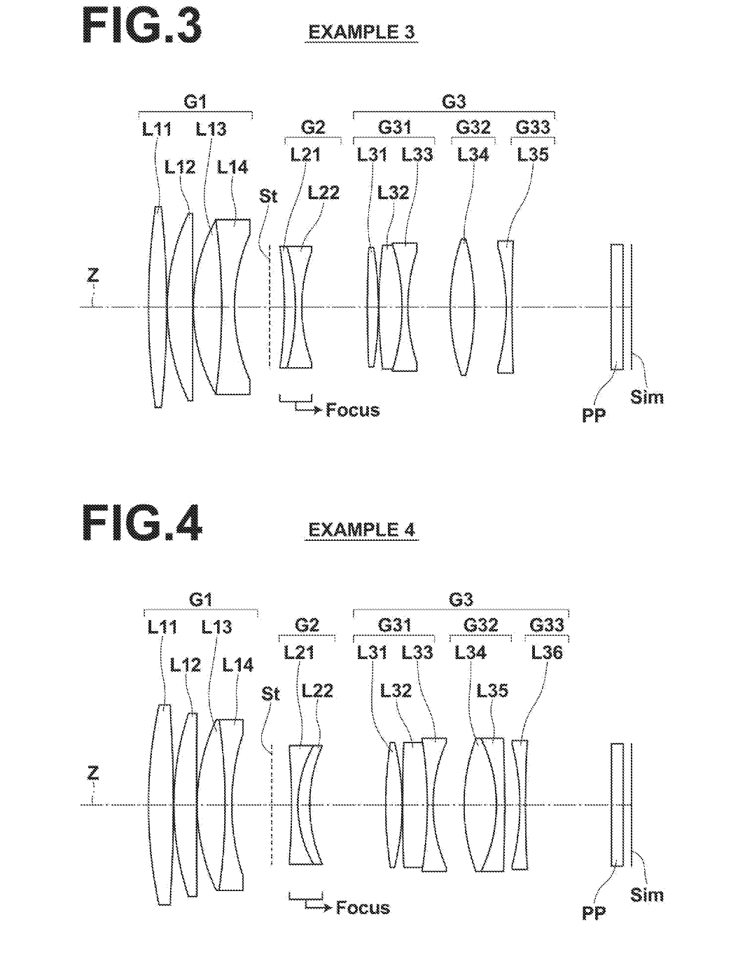

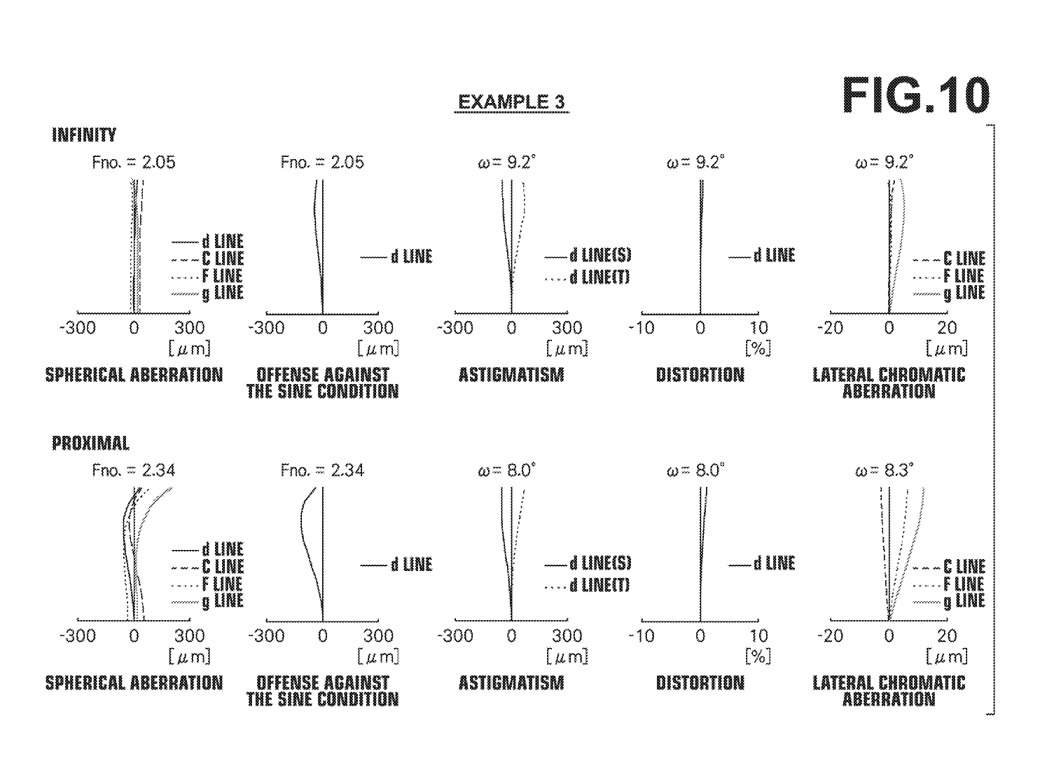

FIG. 3 illustrates the arrangement of lens groups in the imaging lens of Example 3. Tables 5 and 6 show basic lens data and various items of data for the imaging lens of Example 3, respectively. In addition, FIG. 10 shows diagrams that illustrate aberrations of the imaging lens of Example 3.

TABLE 5
Example 3

| Si | Ri | Di | Ndj | νdj | θgFj |
|---|---|---|---|---|---|
| 1 | 171.10816 | 4.300 | 1.53172 | 48.84 | 0.56309 |
| 2 | −216.95802 | 0.150 | | | |
| 3 | 50.87975 | 6.000 | 1.49700 | 81.61 | 0.53887 |
| 4 | ∞ | 0.150 | | | |
| 5 | 42.08665 | 6.710 | 1.61800 | 63.33 | 0.54414 |
| 6 | −147.07879 | 3.000 | 1.74950 | 35.33 | 0.58189 |
| 7 | 41.93466 | 8.300 | | | |
| 8 (St) | ∞ | DD [8] | | | |
| 9 | −94.61489 | 2.610 | 1.95906 | 17.47 | 0.65993 |
| 10 | −51.15155 | 1.500 | 1.65844 | 50.88 | 0.55612 |
| 11 | 37.19456 | DD [11] | | | |
| 12 | 284.45806 | 2.600 | 1.49700 | 81.54 | 0.53748 |
| 13 | −87.31973 | 0.100 | | | |
| 14 | 115.45097 | 5.510 | 1.83481 | 42.72 | 0.56486 |
| 15 | −48.31101 | 1.350 | 1.67270 | 32.10 | 0.59891 |
| 16 | 40.98217 | 10.000 | | | |
| 17 | 49.21220 | 5.750 | 1.71300 | 53.87 | 0.54587 |
| 18 | −62.20075 | 7.500 | | | |
| 19 | −51.68723 | 1.350 | 1.54814 | 45.78 | 0.56859 |
| 20 | 399.48375 | 23.401 | | | |
| 21 | ∞ | 2.850 | 1.51633 | 64.14 | 0.53531 |
| 22 | ∞ | | | | |

TABLE 6
Example 3

| | Infinity | Proximal |
|---|---|---|
| f | 90.000 | |
| Bf | 27.281 | |
| FNo. | 2.05 | 2.34 |
| 2ω | 18.4 | 16.0 |
| β | 0.00 | 0.14 |
| DD [8] | 3.500 | 11.216 |
| DD [11] | 15.500 | 7.784 |

### EXAMPLE 4

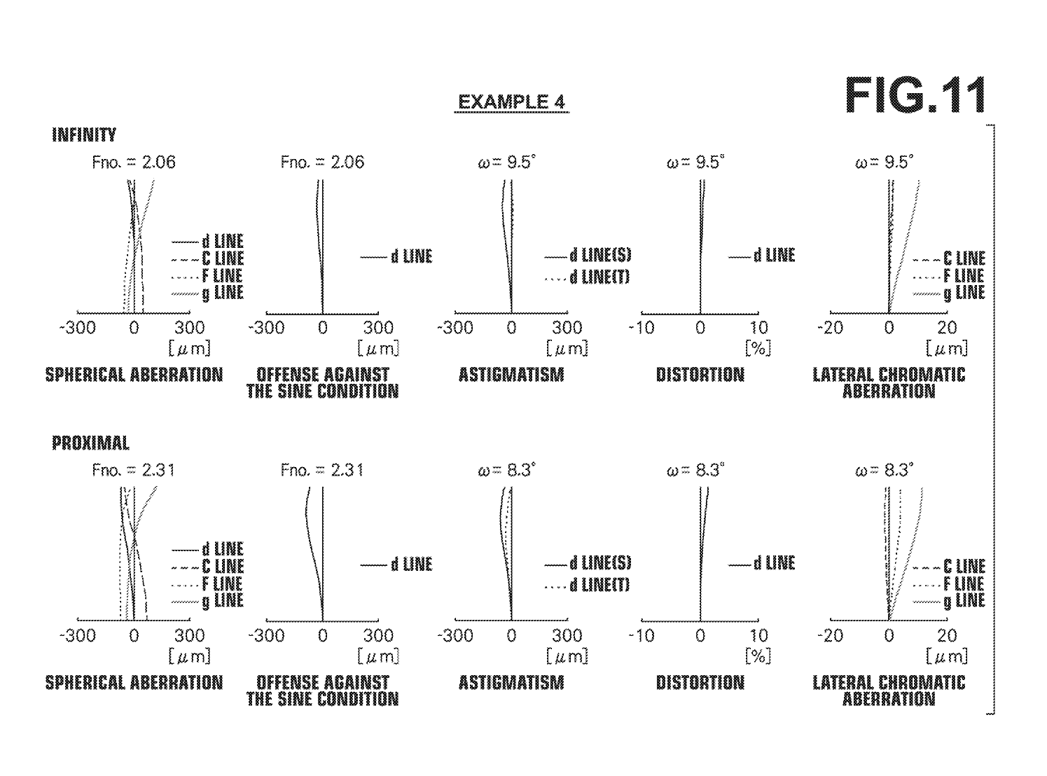

FIG. 4 illustrates the arrangement of lens groups in the imaging lens of Example 4. Example 4 is an example of a configuration in which the third lens group G3 is of a six lens configuration constituted by lenses L31 through L36, in which the third-group second lens group G32 is constituted by one cemented lens formed by cementing two lenses L34 and L35 together. Tables 7 and 8 show basic lens data and various items of data for the imaging lens of Example 4, respectively. In addition, FIG. 11 shows diagrams that illustrate aberrations of the imaging lens of Example 4.

TABLE 7
Example 4

| Si | Ri | Di | Ndj | νdj | θgFj |
|---|---|---|---|---|---|
| 1 | 113.20817 | 6.000 | 1.56384 | 60.67 | 0.54030 |
| 2 | −380.00065 | 0.150 | | | |
| 3 | 70.00000 | 5.500 | 1.49700 | 81.61 | 0.53887 |
| 4 | 5887.83753 | 0.150 | | | |
| 5 | 47.82264 | 6.760 | 1.61800 | 63.33 | 0.54414 |
| 6 | −144.23297 | 1.590 | 1.72047 | 34.71 | 0.58350 |
| 7 | 54.56241 | 9.705 | | | |
| 8 (St) | ∞ | DD [8] | | | |
| 9 | −157.76582 | 1.510 | 1.63854 | 55.38 | 0.54858 |
| 10 | 28.56138 | 2.850 | 1.92286 | 18.90 | 0.64960 |
| 11 | 34.57598 | DD [11] | | | |
| 12 | 97.87959 | 4.000 | 1.60300 | 65.44 | 0.54022 |
| 13 | −61.34955 | 0.100 | | | |
| 14 | 411.38749 | 6.010 | 1.80400 | 46.58 | 0.55730 |
| 15 | −95.45173 | 1.350 | 1.67270 | 32.10 | 0.59891 |
| 16 | 36.32093 | 7.500 | | | |
| 17 | 45.67941 | 7.860 | 1.88300 | 40.76 | 0.56679 |
| 18 | −35.68214 | 2.000 | 1.68893 | 31.07 | 0.60041 |
| 19 | −384.43582 | 3.662 | | | |
| 20 | −57.41352 | 1.350 | 1.51633 | 64.14 | 0.53531 |
| 21 | 268.42823 | 20.816 | | | |
| 22 | ∞ | 2.850 | 1.51633 | 64.14 | 0.53531 |
| 23 | ∞ | | | | |

TABLE 8
Example 4

| | Infinity | Proximal |
|---|---|---|
| f | 87.321 | |
| Bf | 24.697 | |
| FNo. | 2.06 | 2.31 |
| 2ω | 19.0 | 16.6 |
| β | 0.00 | 0.13 |
| DD [8] | 4.794 | 13.047 |
| DD [11] | 18.380 | 10.127 |

### EXAMPLE 5

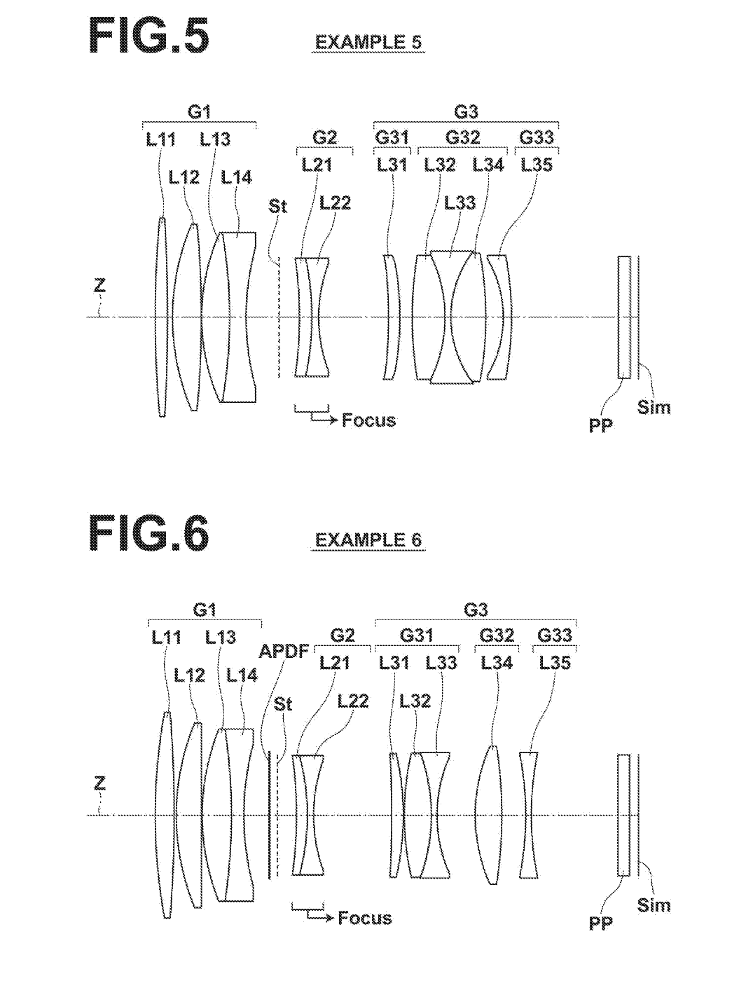

FIG. 5 illustrates the arrangement of lens groups in the imaging lens of Example 5. Example 5 is an example of a configuration in which the third-group first lens group G31 is constituted by one single lens L31, and the third-group second lens group G32 is constituted by one cemented lens formed by cementing three lenses L32, L33, and L34 together.

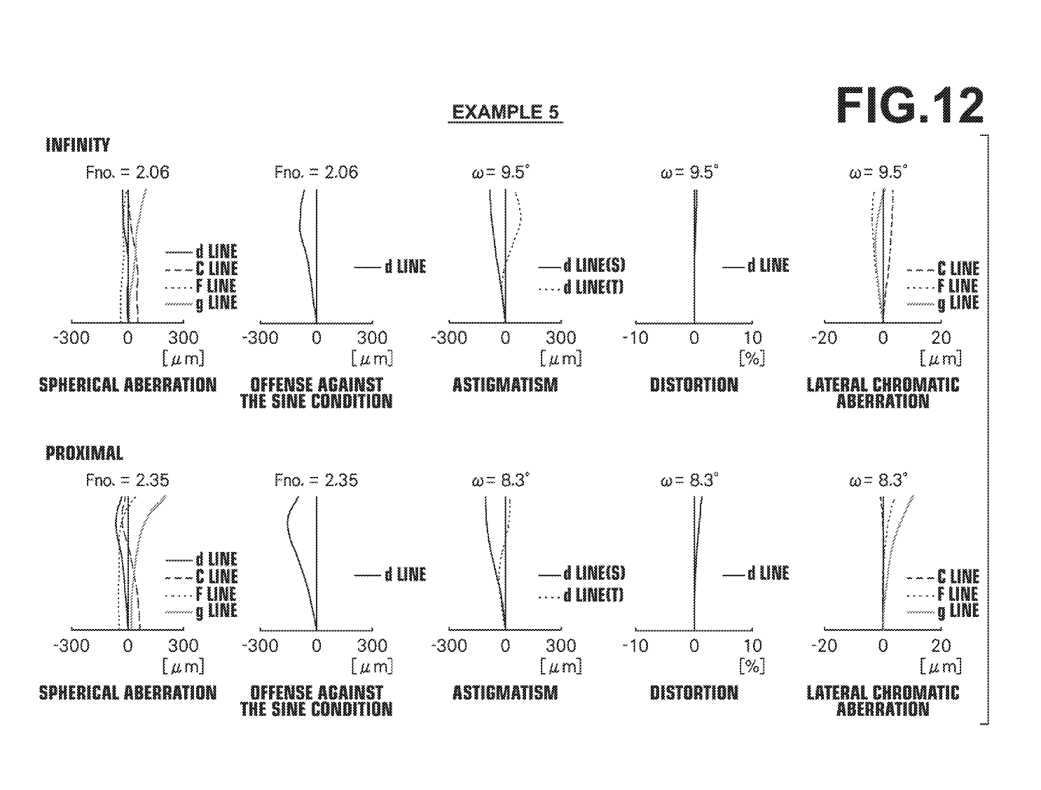

Tables 9 and 10 show basic lens data and various items of data for the imaging lens of Example 5, respectively. In the basic lens data of Table 9, the surface numbers of aspherical surfaces are denoted with the mark “*”, and the radii of curvature of paraxial regions are shown as the radii of curvature of the aspherical surfaces. Note that the shapes of the surfaces of the lenses and the signs of the refractive indices thereof are considered in the paraxial region for lenses that include aspherical surfaces. Table 11 shows aspherical surface data for the imaging lens of Example 5. In addition, FIG. 12 shows diagrams that illustrate aberrations of the imaging lens of Example 5. Table 11 shows the surface numbers of the aspherical surfaces and the aspherical surface coefficients related to these aspherical surfaces. Here, in the numerical values of the aspherical surface data, “E-n (n:integer)” means “·10⁻ⁿ”. Note that the aspherical surface coefficients are the values of the coefficients KA and Am (m=3, 4, 5, . . . , 20) in the following aspherical surface formula:

$$Zd = \frac{C \times {h}^{2}}{1 + \sqrt{1 - KA \times {C}^{2} \times {h}^{2}}} + {\sum }_{m} Am \times {h}^{m} \qquad [ Formula 1 ]$$

wherein: Zd is the depth of the aspherical surface (the length of a normal line that extends from a point on the aspherical surface having a height h to a plane perpendicular to the optical axis that contacts the peak of the aspherical surface), h is the height (the distance from the optical axis to the surface of the lens), C is the inverse of the paraxial radius of curvature, and KA and Am are aspherical surface coefficients (m=3, 4, 5, . . . , 20).

TABLE 9
Example 5

| Si | Ri | Di | Ndj | νdj | θgFj |
|---|---|---|---|---|---|
| 1 | 256.04217 | 3.000 | 1.51742 | 52.43 | 0.55649 |
| 2 | −416.45669 | 1.220 | | | |
| 3 | 56.55825 | 7.000 | 1.49700 | 81.54 | 0.53748 |
| 4 | −246.42222 | 0.100 | | | |
| 5 | 49.87626 | 6.810 | 1.60300 | 65.44 | 0.54022 |
| 6 | −117.49447 | 4.000 | 1.83400 | 37.16 | 0.57759 |
| 7 | 63.73847 | 8.000 | | | |
| 8 (St) | ∞ | DD [8] | | | |
| 9 | −95.63732 | 3.010 | 2.00272 | 19.32 | 0.64514 |
| 10 | −67.19060 | 1.650 | 1.53775 | 74.70 | 0.53936 |
| 11 | 36.59838 | DD [11] | | | |
| * 12 | −98.28826 | 2.750 | 1.55332 | 71.68 | 0.54029 |
| * 13 | −75.00000 | 3.000 | | | |
| 14 | 89.66312 | 8.010 | 1.69680 | 55.53 | 0.54341 |
| 15 | −33.71288 | 1.410 | 1.59551 | 39.24 | 0.58043 |
| 16 | 26.05104 | 8.500 | 1.75500 | 52.32 | 0.54765 |
| 17 | −84.47282 | 4.258 | | | |
| 18 | −27.49980 | 2.000 | 1.51633 | 64.14 | 0.53531 |
| 19 | −77.73467 | 26.039 | | | |
| 20 | ∞ | 2.850 | 1.51633 | 64.14 | 0.53531 |
| 21 | ∞ | | | | |

* aspherical surface

| | Infinity | Proximal |
|---|---|---|
| f | 87.284 | |
| Bf | 29.919 | |
| FNo. | 2.06 | 2.35 |
| 2ω | 19.0 | 16.6 |
| β | 0.00 | 0.14 |
| DD [8] | 5.000 | 14.376 |
| DD [11] | 17.000 | 7.624 |

TABLE 11
Example 5

| Surface Number | 12 | 13 |
|---|---|---|
| KA | 1.0000000E+00 | 1.0000000E+00 |
| A3 | −1.1422608E−05 | −1.1351787E−05 |
| A4 | 9.7469924E−06 | 3.9502577E−06 |
| A5 | 2.4521799E−07 | 3.4171182E−07 |
| A6 | 1.3221296E−09 | −6.0449277E−09 |
| A7 | −8.6693458E−10 | −1.6641184E−09 |
| A8 | −1.0747008E−10 | −1.0934156E−10 |
| A9 | −7.8994198E−12 | −3.7620680E−12 |
| A10 | −3.6319760E−13 | 1.9147710E−15 |
| A11 | −5.9314083E−15 | 5.0499868E−15 |
| A12 | 1.1758217E−15 | 3.7424058E−16 |
| A13 | 1.4712149E−16 | 3.7242945E−18 |
| A14 | 1.0835327E−17 | −2.0585811E−18 |
| A15 | 2.6174460E−19 | −2.9476744E−19 |
| A16 | −2.6169408E−20 | −1.1098269E−20 |
| A17 | −4.8675474E−21 | 5.0994173E−22 |
| A18 | −4.2571379E−22 | 9.2017809E−23 |
| A19 | −1.1512165E−23 | 3.6464740E−24 |
| A20 | 2.6949871E−24 | −4.1095806E−25 |

### EXAMPLE 6

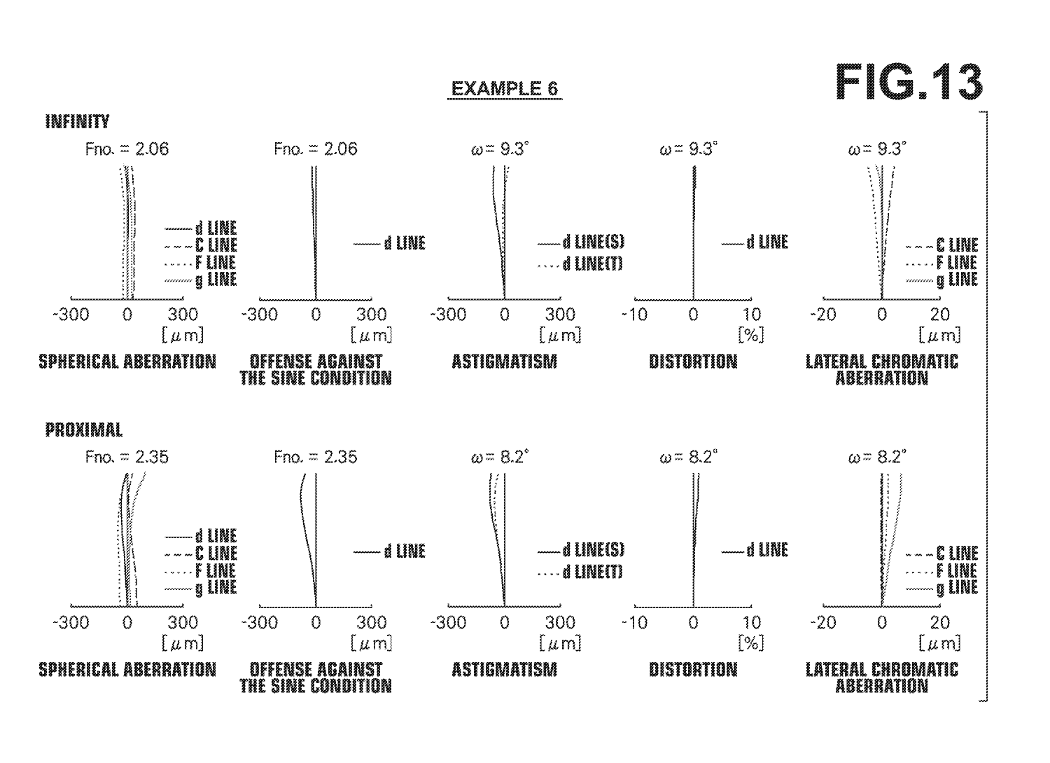

FIG. 6 illustrates the arrangement of lens groups in the imaging lens of Example 6. Tables 12 shows basic lens data for the imaging lens of Example 6, and Table 13 shows data related to various items and the distances among moving surfaces. In addition, FIG. 13 shows diagrams that illustrate aberrations of the imaging lens of Example 6. The configuration of the imaging lens of Example 6 is the same as that of the imaging lens of Example 1, except that an APD filter APDF is provided adjacent to the aperture stop St at the object side thereof. In Example 6, the APD filter APDF is positioned adjacent to the aperture stop St at the object side thereof, but the APD filter APDF may alternatively be positioned adjacent to the aperture stop St at the image side thereof.

Note that the imaging lenses of Example 6 and Example 1 are configured such that (1) the distance along the optical axis from the lens surface of the imaging lens most toward the object side to the lens surface of the imaging lens most toward the image side in a state focused on an object at infinity and (2) the distance along the optical axis from the lens surface within the second lens group G2 most toward the image side to the lens surface within the third lens group G3 most toward the object side in a state focused on an object at infinity are equal. For this reason, the imaging lens of Example 6 may be considered to be an example of a configuration in which the focus position is shifted from that of the imaging lens of Example 1 for an amount corresponding to the thickness along the optical axis of the APD filter APDF.

TABLE 12
Example 6

| Si | Ri | Di | Ndj | νdj | θgFj |
|---|---|---|---|---|---|
| 1 | 134.54219 | 4.550 | 1.51633 | 64.14 | 0.53531 |
| 2 | −308.48240 | 0.520 | | | |
| 3 | 57.11452 | 6.050 | 1.49700 | 81.61 | 0.53887 |
| 4 | ∞ | 0.180 | | | |
| 5 | 54.95203 | 7.010 | 1.59522 | 67.73 | 0.54426 |
| 6 | −138.92000 | 3.000 | 1.74950 | 35.33 | 0.58189 |
| 7 | 65.12954 | 6.029 | | | |
| 8 | ∞ | 0.200 | 1.53000 | 56.00 | 0.55058 |
| 9 | ∞ | 1.821 | | | |
| 10 (St) | ∞ | DD [10] | | | |
| 11 | −99.96703 | 2.610 | 1.92286 | 18.90 | 0.64960 |
| 12 | −53.99500 | 1.490 | 1.63854 | 55.38 | 0.54858 |
| 13 | 38.38332 | DD [13] | | | |
| 14 | −299.93361 | 2.800 | 1.59522 | 67.73 | 0.54426 |
| 15 | −65.51447 | 0.250 | | | |
| 16 | 65.03027 | 6.510 | 1.83481 | 42.72 | 0.56486 |
| 17 | −43.00300 | 1.350 | 1.67270 | 32.10 | 0.59891 |
| 18 | 33.75440 | 9.180 | | | |
| 19 | 39.82254 | 6.400 | 1.71300 | 53.87 | 0.54587 |
| 20 | −107.03524 | 5.750 | | | |
| 21 | −75.17060 | 1.350 | 1.51742 | 52.43 | 0.55649 |
| 22 | 75.17060 | 20.784 | | | |
| 23 | ∞ | 2.850 | 1.51633 | 64.14 | 0.53531 |
| 24 | ∞ | | | | |

TABLE 13
Example 6

| | Infinity | Proximal |
|---|---|---|
| f | 87.463 | |
| Bf | 24.770 | |
| FNo. | 2.06 | 2.35 |
| 2ω | 18.6 | 16.4 |
| β | 0.00 | 0.14 |
| DD [10] | 4.600 | 12.692 |
| DD [13] | 18.753 | 10.661 |

Table 14 shows values corresponding to Conditional Formula (1) through (7) for each of the imaging lenses of Examples 1 through 6. As shown in Table 14, all of Conditional Formulae (1) through (7) are satisfied in each of the imaging lenses 1 of Examples 1 through 6, and further, all of Conditional Formulae (1-1) through (7-1), (1-2), (2-2), and (7-2), which define more favorable ranges within the ranges defined by Conditional Formulae (1) through (7), are satisfied. The advantageous effects obtained by these configurations are as described in detail previously.

TABLE 14

| Formula | Condition | Example 1 | | | Example 2 | | | Example 3 | |
|---|---|---|---|---|---|---|---|---|---|
| | | L11 | L12 | L13 | L11 | L12 | L13 | L12 | L13 |
| 1 | νd_G1p2 | 64.14 | 81.61 | 67.73 | 64.14 | 81.61 | 74.70 | 81.61 | 63.33 |

| 2 | νd_G1pm | 64.14 | | | 64.14 | | 48.84 | | |
|---|---|---|---|---|---|---|---|---|---|
| 3 | TL/f | 1.315 | | | 1.424 | | 1.257 | | |
| 4 | \|f2\|/f | 0.549 | | | 0.593 | | 0.501 | | |
| 5 | Bf/f | 0.282 | | | 0.251 | | 0.303 | | |
| 6 | D23/TL | 0.163 | | | 0.155 | | 0.137 | | |
| | | L12 | | | L12 | L13 | L12 | | |
| 7 | νd_G1p1 | 81.61 | | | 81.61 | 74.70 | 81.61 | | |
| Formula | Condition | Example 4 | | | Example 5 | | Example 6 | | |
| | | L11 | L12 | L13 | L12 | L13 | L11 | L12 | L13 |
| 1 | νd_G1p2 | 60.67 | 81.61 | 63.33 | 81.54 | 65.44 | 64.14 | 81.61 | 67.73 |

| 2 | νd_G1pm | 60.67 | 52.43 | 64.14 |
|---|---|---|---|---|
| 3 | TL/f | 1.328 | 1.336 | 1.317 |
| 4 | \|f2\|/f | 0.555 | 0.622 | 0.550 |
| 5 | Bf/f | 0.283 | 0.343 | 0.283 |
| 6 | D23/TL | 0.159 | 0.146 | 0.163 |
| | | L12 | L12 | L12 |
| 7 | νd_G1p1 | 81.61 | 81.54 | 81.61 |

Note that FIG. 1 illustrates an example in which the optical member PP is provided between the lens system and the image formation plane Sim. Alternatively, various filters such as low pass filters and filters that cut off specific wavelength bands may be provided among each of the lenses instead of being provided between the lens system and the image formation plane Sim. As a further alternative, coatings that have the same functions as the various filters may be administered on the surfaces of the lenses.

As can be understood from each of the above sets of numerical value data and the diagrams that illustrate aberrations, the imaging lenses of Examples 1 through 6 have small F values of 2.1 or less when focused on an object at infinity and achieve a large aperture ratio. It can also be understood that various aberrations are favorably corrected both when focused at infinity and when focused at a most proximal distance. In addition, the focal lengths of the imaging lenses of Examples 1 through 6 are 100 mm or greater as 35 mm equivalent converted values. These focal lengths are favorably suited for use in medium telephoto imaging or telephoto imaging. Particularly, 35 mm equivalent converted focal lengths within a range from 120 mm to 140 mm are favorably suited for use in medium telephoto imaging or telephoto imaging.

### (Embodiment of Imaging Apparatus)

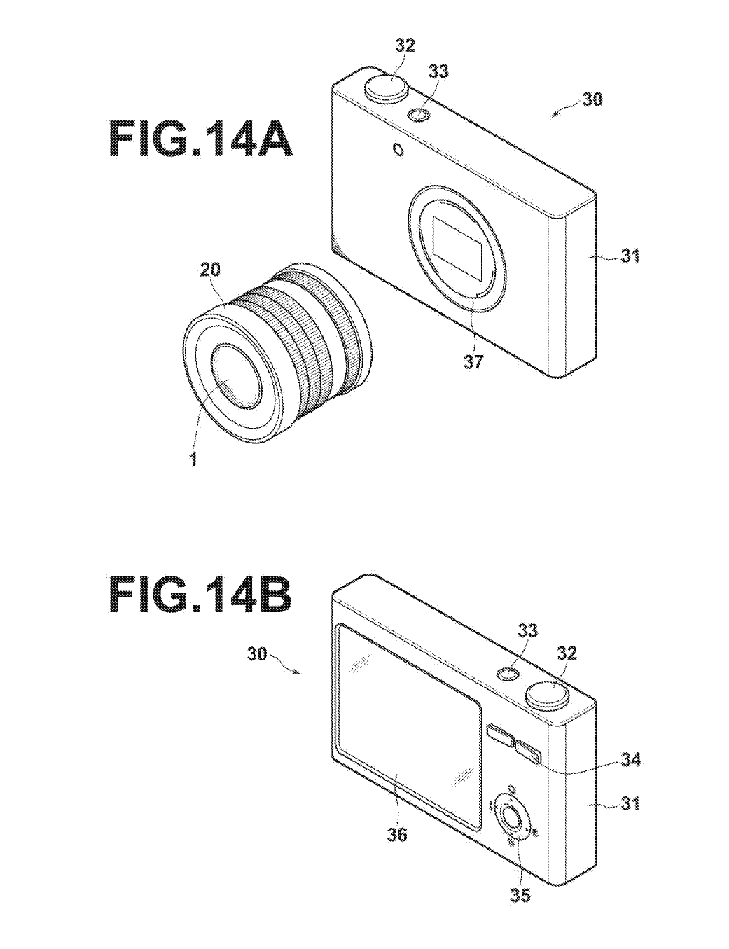

Next, an imaging apparatus according to an embodiment of the present disclosure will be described with reference to FIG. 14A and FIG. 14B. A camera 30 illustrated in the perspective views of FIG. 14A and FIG. 14B is a so called mirrorless single lens digital camera, onto which an exchangeable lens 20 is interchangeably mounted. FIG. 14A illustrates the outer appearance of the camera 30 as viewed from the front, and FIG. 14B illustrates the outer appearance of the camera 30 as viewed from the rear.

The camera 30 is equipped with a camera body 31. A shutter release button 32 and a power button 33 are provided on the upper surface of the camera body 31. Operating sections 34 and 35 and a display section 36 are provided on the rear surface of the camera body 31. The display section 36 displays images which have been photographed and images within the angle of view prior to photography.

A photography opening, in to which light from targets of photography enters, is provided at the central portion of the front surface of the camera body 31. A mount 37 is provided at a position corresponding to the photography opening. The exchangeable lens 20 is mounted onto the camera body 31 via the mount 37. The exchangeable lens 20 is the imaging lens 1 of the present disclosure housed in a lens barrel.

An imaging element (not shown), such as a CCD that receives images of subjects formed by the exchangeable lens 20 and outputs image signals corresponding to the images, a signal processing circuit that processes the image signals output by the imaging element to generate images, and a recording medium for recording the generated images, are provided within the camera body 31. In this camera 30, photography of still images and videos is enabled by pressing the shutter release button 32. Image data obtained by photography or video imaging are recorded in the recording medium.

By applying the imaging lens of the present disclosure as the interchangeable lens 20 for use in such a mirrorless single lens camera 30, the camera 30 can be sufficiently compact even in a state in which the lens is mounted. In addition, images obtained by the camera 30 can be those having favorable image quality.

The present disclosure has been described with reference to the embodiments and Examples thereof. However, the present disclosure is not limited to the embodiments and Examples described above, and various modifications are possible. For example, the values of the radii of curvature, the distances among surfaces, the refractive indices, the Abbe's numbers, the aspherical surface coefficients of each lens component, etc., are not limited to the numerical values indicated in connection with the Examples, and may be other values.

What is claimed is:

1. An imaging lens consisting of, in order from the object side to the image side:
a first lens group having a positive refractive power;
a second lens group having a negative refractive power; and
a third lens group having a positive refractive power;
an aperture stop being positioned at the object side of the second lens group;
the first lens group having at least two positive lenses and at least one negative lens;
the second lens group consisting of at least one positive lens and at least one negative lens;
the third lens group having at least two positive lenses and at least two negative lenses that include at least one cemented lens; and
the second lens group moving along the optical axis from the object side to the image side while the first lens group and the third lens group are fixed with respect to an image formation plane to change focus from an object at infinity to an object at a proximal distance.

2. An imaging lens as defined in claim 1, wherein:
the aperture stop is positioned between a lens surface most toward the image side within the first lens group and a lens surface most toward the object side within the second lens group; and
the aperture stop is fixed with respect to the image formation plane during focusing operations.

3. An imaging lens as defined in claim 1, wherein:
the second lens group consists of a cemented lens formed by cementing one positive lens and one negative lens together.

4. An imaging lens as defined in claim 1, wherein:
the first lens group has at least three positive lenses and at least one negative lens.

5. An imaging lens as defined in claim 4, wherein:
the first lens group consists of at least three positive lenses and at least one negative lens.

6. An imaging lens as defined in claim 1, in which the conditional formula below is satisfied:
58<νd_G1p2 (1)
wherein νd_G1p2 is the Abbe's number with respect to the d line of at least two of the positive lenses from among the positive lenses included in the first lens group.

7. An imaging lens as defined in claim 1, in which the conditional formula below is satisfied:
43<νd_G1pm (2)
wherein νd_G1pm is the smallest Abbe's number among the Abbe's numbers with respect to the d line of the positive lenses included in the first lens group.

8. An imaging lens as defined in claim 1, wherein:
the third lens group has a lens component having a negative refractive power at the most image side within the third lens group.

9. An imaging lens as defined in claim 1, in which the conditional formula below is satisfied:
1.0<TL/f<1.6 (3)
wherein TL is the distance along the optical axis from the lens surface most toward the object side within the first lens group to the image formation plane with back focus as an air converted distance, f is the focal length of the entire lens system in a state focused on an object at infinity.

10. An imaging lens as defined in claim 1, in which the conditional formula below is satisfied:
0.3<|f2|/f<0.8 (4)
wherein f2is the focal length of the second lens group, and f is the focal length of the entire lens system in a state focused on an object at infinity.

11. imaging lens as defined in claim 1, wherein:
the first lens group consists of, in order from the object side to the image side, a positive lens, a positive lens, a positive lens, and a negative lens.

12. An imaging lens as defined in claim 1, in which the conditional formula below is satisfied:
0.2<Bf/f<0.4 (5)
wherein Bf is the distance along the optical axis from the lens surface most toward the image side within the third lens group to the image formation plane as an air converted distance, and f is the focal length of the entire lens system in a state focused on an object at infinity.

13. An imaging lens as defined in claim 1, in which the conditional formula below is satisfied:
0.1<D23/TL<0.2 (6)
wherein D23 is the distance along the optical axis from the lens surface most toward the image side within the second lens group to the lens surface most toward the object side within the third lens group in a state focused on an object at infinity, and TL is the distance along the optical axis from the lens surface most toward the object side within the first lens group to the image formation plane with back focus as an air converted distance.

14. An imaging lens as defined in claim 1, in which the conditional formula below is satisfied:
70<νd_G1p1 (7)
wherein νd_G1p1 is the Abbe's number with respect to the d line of at least one lens from among the positive lenses included in the first lens group.

15. An imaging lens as defined in claim 1, wherein:
the third lens group consists of, in order from the object side to the image side, a third-group first lens group having a positive refractive power, a third-group second lens group having a positive refractive power, and a third-group third lens group having a negative refractive power;
the third-group first lens group and the third group-second lens group are separated by one of the largest and the second largest air distances along the optical axis from among the air distances among adjacent lenses within the third lens group; and
the third-group second lens group and the third-group third lens group are separated by the other of the largest and the second largest air distances.

16. An imaging lens as defined in claim 15, wherein:
the third-group first lens group has at least one cemented lens;
the third-group second lens group consists of one lens component having a positive refractive power; and
the third-group third lens group consists of one lens component having a negative refractive power.

17. An imaging lens as defined in claim 1, wherein:
the third lens group has a single lens having a negative refractive power at the most image side within the third lens group.

18. An imaging lens as defined in claim 1, wherein:
the imaging lens consists of at most twelve lenses as a whole.

19. An imaging lens as defined in claim 1, wherein:
the aperture stop is positioned at the image side of the lens surface most toward the object side within the first lens group; and
a filter, of which the transmissivity decreases as the distance from the optical axis increases, is positioned adjacent to the aperture stop at one of the object side and the image side thereof.

20. An imaging apparatus equipped with an imaging lens as defined in claim 1.
